(19) United States
(12) Patent Application Publication
(10) Pub. No.: US 2003/0223214 A1
(43) Pub. Date: Dec. 4, 2003

(54) Mount device and method

(75) Inventor: Hirooki Hayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/446,809

(22) Filed: May 29, 2003

(30) Foreign Application Priority Data
May 30, 2002 (JP) 2002-157034

(51) Int. Cl. H02B 1/01

(52) U.S. Cl. 361/825

(57) ABSTRACT

A mount device for mounting an object onto a predetermined position on a base includes a support part including a first support surface for supporting one surface of the object, and a second support surface for supporting another surface of the object that neighbors the one surface of the object, and a suction nozzle for absorbing the object through the first and/or second surfaces.

### BACKGROUND OF THE INVENTION

The present invention relates generally to mounting of an object, and more particularly to an apparatus and method for positioning or aligning, and mounting the object. The present invention is suitable, for example, for a suction collet, an apparatus having the collet, and a method using the collet, which collet positions and mounts an object, such as an optical device part, an optical element (for example, a laser diode (“LD” hereinafter), a photodiode (“PD” hereinafter), and a semiconductor device, onto a base, a container, and other base members.

As hardware has recently been increasingly demanded to be smaller, electronic and optical devices to be mounted onto the hardware have been required to be smaller, and thus the mounting accuracy has become stricter. For example, in mounting the LD chip onto a base and bonding them, the LD chip should be arranged in place apart from a marking formed on the base.

Conventionally, a collet has been used which absorbs a LD from a pallet for accommodating multiple LDs, and moves the LD to the base in order to mount onto the base and solder-boding the LD chip. The conventional collet forms a center suction nozzle, which has a rectangular section in the longitudinal direction and enables the collet to absorb the top of the LD through its bottom that draws a vacuum.

Referring now to FIG. 10, a description will be given of the conventional mount method. FIG. 10A is a schematic sectional view showing that a collet 20 is about to absorb a LD 30 mounted on (a concave 12 in) a pallet 10. The LD 30 has a rectangular-parallelpiped shape and is accommodated in the concave 12 in the pallet 10 in an arrow direction. The collet 20 forms, along its longitudinal direction (or direction A₁-A₂), a suction nozzle 22 that draws a vacuum or decreased pressure. The collet 20 goes down in the direction A₂ from a state shown in FIG. 10A, and the bottom surface 24 of the collet 20 closely contacts a top surface 32 of the LD 30.

FIG. 10B is a schematic sectional view showing that the camera 40 is taking a picture of the LD 30 carried by the collet 20 for a rough search. The camera 40 has a field, for example, of 0.6 mm×0.5 mm, and observes an offset of the LD 30 from a reference position. Here, FIG. 10C shows a bottom view of the LD 30. The bottom of the LD 30 has a size of 0.2 mm×0.7 mm, and forms a pair of markings 34 at two corners, respectively.

FIG. 10D is a schematic sectional view showing that the LD 30 carried by the collet 20 is about to be mounted on the base 50 that has been provided on a bonding stage 70. The base 50 shows a marking 52 used to position the LD 30 in micron level order. FIG. 10E shows a schematic sectional view of FIG. 10D viewed from a direction B. As shown in FIG. 10E, an end face 36 of the LD 30 should be arranged in place with a predetermined distance L₂ from the marking 52. In positioning, the center of two markings 34 is set to be a reference point. The predetermined distance L₂ should be maintained with accuracy for bonding the LD 30 with accuracy. The camera 60 always monitors the markings 52, but a drive part 25 of the collet 20 shields the field, as shown in FIG. 10D, when the LD 30 is being mounted, and hinders the LD 30 and markings 52 from being captured in the same field.

Regarding the positioning accuracy of L₂, the LD 30 is minutely movable and rotatable in the concave 12 in the pallet 10, as shown in FIG. 10A. The camera 40 photographs the LD 30 and memorizes a position and orientation of the LD 30 relative to the pallet 10 through image processing. On the other hand, the camera 60 photographs the markings 52, confirms and memorizes their positions through image processing. Based on data obtained by processing images taken by the cameras 40 and 60, the LD 30 is mounted on the base 50 in the direction A₂ shown in FIG. 10D. Once the LD 30 is mounted on the base 50, the camera 60 may capture the LD 30 and markings 52 in its field, and confirms whether L₂ is maintained through processing of an image taken by the camera 60. If necessary, the collet 20 picks up the LD 30 from the base 50 again and corrects its position.

However, the conventional mounting method has several disadvantages: The conventional mounting method has used the camera 40 and an image processor (not shown) connected to the camera 40, and thus has a complex and costly mechanism. When it is determined that L₂ is not maintained as a result of processing images taken by the camera 60, the collet 20 should pick up the LD 30 again to resume the image processes using the cameras 40 and 60. This would spend much time for positioning and lower the yield. No correction would be one conceivable solution, but it would lower the reliability of the LD products. Moreover, as the image processes using the camera 40 and 60 use different systems, which add a recognition error associated with image processing of the camera 40 and a recognition error associated with image processing of the camera 60, lowering the positioning accuracy of the LD 30. For example, when the image processing using the camera 40 contains a recognition error of 0.1 μm and the image processing using the camera 60 contains a recognition error of 0.1 μm, the accuracy of L₂ contains an error of about 0.2 μm, which may possibly result in characteristic deterioration of the LD. The LD 30 often cannot be positioned as the error becomes larger.

### BRIEF SUMMARY OF THE INVENTION

Accordingly, it is an exemplified object of the present invention to provide a mount device and method that realizes at least one of the improved yield, the improved reduction of device's cost, and the improved positioning accuracy.

In order to achieve the above object, a mount device of one aspect of the present invention for mounting an object onto a predetermined position on a base includes a support part including a first support surface for supporting one surface of the object, and a second support surface for supporting another surface of the object that neighbors the one surface of the object, and a suction nozzle for absorbing the object through the first and/or second surfaces. This mount device absorbs two surfaces of the object through the first and/or second support surfaces, approximately fixing a position and orientation of the object relative to the mount device. Therefore, this mount device does not require the camera 40 for the rough search shown in FIG. 10B and the image processor (not shown) connected to the camera 40. Saving the rough-search time would reduce the time necessary to mount the object onto the base. The support part preferably exposes part of the object, because the partial exposure would facilitate positioning of the object.

An angle formed between the first and second surfaces is set larger than that formed between two surfaces on the object. Since manufacture errors often cause a deviation in angle between two surfaces on the object, the angle formed between the first and second surfaces, which has been set larger may absorb the deviation.

The suction nozzle may cover an interface between the first and second support surfaces and have such a biased center that the first and second support surfaces absorb with difference absorbing powers. Preferably, the first support surface absorbs a top surface of the object, the second support surface absorbs a side surface of the object, and the absorptive power of the first support part may be set larger than that of the second support part. As a result of the eager study by the instant inventor, the stable absorption of the object is available when the first and second support surfaces have the different absorptive powers instead of the same power, and the absorptive Dower to the top surface of the object is set to be higher.

The predetermined position may be a predetermined position from a marking provided on the base, and wherein the mount device further includes an imaging part, provided at an upside of the base, which has a field to cover both of the object and marking before the object is mounted on the base, and a drive part for driving the support part so as to move the object toward the base, and correcting an alignment of the object with the marking, when the object is not arranged in place relative to the marking. According to this mount device, the imaging part aligns the object with the marking before the object is mounted onto the base, and the drive part corrects the alignment, eliminating the rough-search camera 40 shown in FIG. 10B and the image processor (not shown) connected to the camera 40. The present invention uses the same image processing system and has higher alignment accuracy of the object with the marking or mounting accuracy of the object than the conventional mounting method that uses different image processing systems. The object may be mounted without being affected by the driving accuracy of the drive part when the object and base are aligned while arranged close to each other in the vertical direction by about 1 μm. For example, suppose that the drive part descends the support part after the alignment conducted with a large vertical distance between the object and the base. In this case, if the driving accuracy of the drive part is not so high that an attempt to vertically descending the object results in the inclined descending of the support part, the object is mounted onto the base at an offset position from a desired position. Accordingly, the present invention aligns the object with the base while arranging the object close to the base so that the mounting is less affected by the driving accuracy of the drive part. The object may be corrected before the object is mounted onto the base, and thus the correction time is shorter than the conventional mount method that cannot determine the necessity of correction until the object is mounted onto the base.

The support part may expose part of the object viewed from the imaging part. The partial exposure would facilitate the alignment of the object with the marking while viewing them from the upside of them. Preferably, the imaging part may be located approximately just above the base, because the imaging part photographing a subject from the upside provides the better accuracy than photographing the subject obliquely. It is conceivable that the imaging part is provided between the base and the object and simultaneously views them in upper and lower directions through mirrors. However, this configuration is complex and expensive, and the insertion of the mirrors generates an offset between the upper and lower optical axes, thereby lowering the recognition accuracy by the imaging part. In addition, the imaging part photographs the object and the base with the different quantity of light or different contrast, and causes the recognition error in image-processing both data. Thus preferably, the imaging part is located above both of the base and the object. The drive part may include, for example, a XYZ stage for linearly moving the support part in three axial directions, and a rotary stage for rotating the support part.

A mount device of another aspect of the present invention for mounting an object onto a predetermined position on a base includes a support part that includes a support surface corresponding to part of a three-dimensional shape of the object and supports the object through the support surface. Thus, the support surface is not limited to two surfaces, but may have three or more surfaces or a shape corresponding to a three-dimensional shape. The object may be a laser diode, and the base may be provided on a bonding stage. The accuracy is particularly required when the laser diode is mounted onto the base.

A pallet of still another aspect of the present invention is used for a mount device that includes a first support part including a first support surface for supporting one surface of the object to be mounted onto a predetermined position on a base, and a second support part including a second support surface for supporting another surface of the object different from the one surface, and includes an accommodation part for accommodating a bottom surface of the object, wherein the first support surface supports a top surface of the object opposite to the bottom surface, and the second support surface supports a side surface of the object different from the top and bottom surfaces of the object, the depth of the accommodation part partially exposing the side surface of the object accommodated, and the second support surface covering part of the exposed side surface. This pallet uses a preset depth of the accommodation part to prevent a collision with the second surface of the mount device.

A method of still another aspect of the present invention for mounting an object onto a base includes the steps of carrying the object to an upside of the base, and capturing the object and a marking formed on the base simultaneously in the same field viewed from the upside of the base, and aligning the object with the marking using an imaging part located above the object and the base. According to this mount method, the imaging part aligns the object with the marking before the object is mounted onto the base, and the drive part corrects the alignment. Therefore, this mount method does not require the rough-search camera 40 shown in FIG. 10B and image processor (not shown). The present invention uses the same image processing system and has higher alignment accuracy of the object with the marking or mounting accuracy of the object than the conventional mounting method that uses different image processing systems. The object may be corrected before mounted onto the base, and thus the correction time becomes shorter than the conventional mount method that cannot determine the necessity of the correction until the object is mounted onto the base. The imaging part photographing over the base and the object provides the better accuracy than photographing them obliquely. It is conceivable that the imaging part is provided between the base and the object and simultaneously views them in the upper and lower directions through mirrors. However, this configuration is complex and expensive, and the insertion of the mirrors would cause an offset between the optical axes, thereby lowering the recognition accuracy of the imaging part. The imaging part photographs the object and the base with the different quantity of light or different contrast would cause the recognition error in image-processing both data. Thus preferably, the imaging part is located above both of the base and the object.

Preferably, the aligning step is executed when the object is arranged close to the base in a vertical direction within a predetermined distance. In particular, the object may be mounted with little influence of the driving accuracy of the drive part when the alignment is conducted with a short distance between the object and the base in the vertical direction such as about 1 μm. For example, suppose that the drive part descends the support part after the alignment conducted with a large vertical distance between the object and the base. In this case, if the driving accuracy of the drive part is not so high that an attempt to vertically descending the object results in the inclined descending of the support part, the object is mounted onto the base at an offset position from a desired position. Accordingly, the present invention aligns the object with the base after arranging the object close to the base so that the mounting is less affected by the driving accuracy by the drive part.

Other objects and further features of the present invention will become readily apparent from the following description of the embodiments with reference to accompanying drawings.

### BRIEF DESCRIPTION OF THE DRAWINGS

FIG. 1 is a schematic perspective view of a mount system of one embodiment according to the present invention.

FIG. 2 is a schematic sectional view of a pallet used for the mount system shown in FIG. 1

FIG. 3 is a schematic perspective view of the pallet shown in FIG. 1 for accommodating laser diode chips in a matrix array.

FIG. 4 is a schematic block diagram of a control system of the mount device shown in FIG. 1.

FIG. 5 is a partial sectional view showing a structure of a collet used for the mount device shown in FIG. 1.

FIG. 6 is a flowchart for explaining an operation of the control system shown in FIG. 4.

FIG. 7 is schematic top and perspective views showing that the collet shown in FIG. 2 absorbs the laser diode chip.

FIG. 8 is a schematic plane view showing a field of a camera shown in FIG. 4.

FIG. 9 is a schematic sectional view of a variation of the camera shown in FIG. 4.

FIG. 10 is schematic views of a conventional mount method.

### DETAILED DESCRIPTION OF THE INVENTION

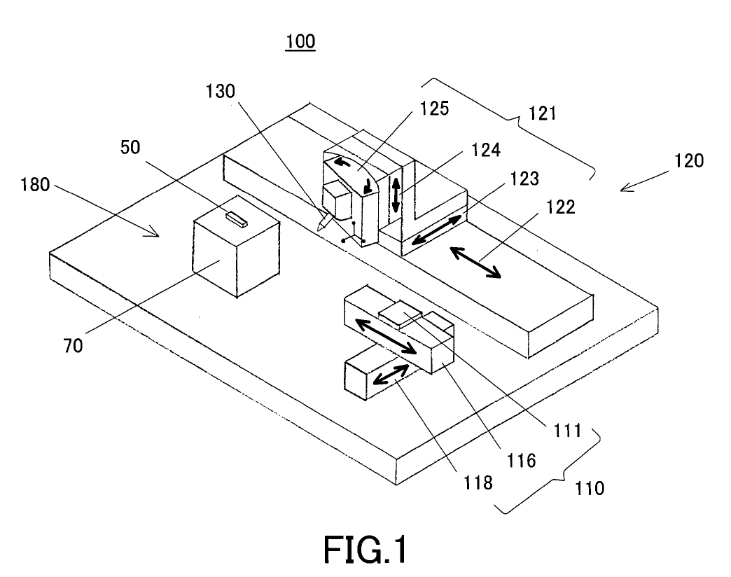

Referring now to FIG. 1, a description will be given of a mount system 100 of one embodiment according to the present invention. Here, FIG. 1 is a schematic perspective view of a mount system 100. The mount system 100 includes a pallet part 110, a mount device 120, and a base part 180, uses the mount device 120 to pick up and carry the LD 30 as an object to be bonded from the pallet part 110 to the base 50, mount the LD 30 on the base 50 with a predetermined alignment, and enables the base 50 to be bonded later.

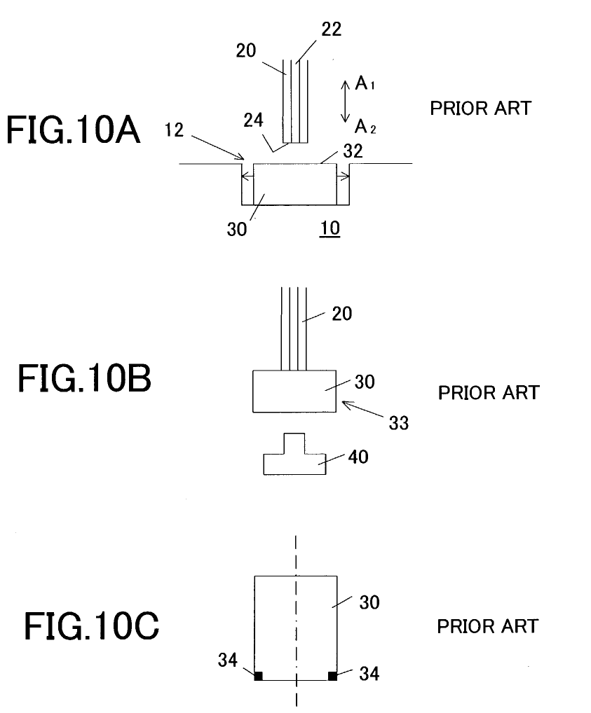

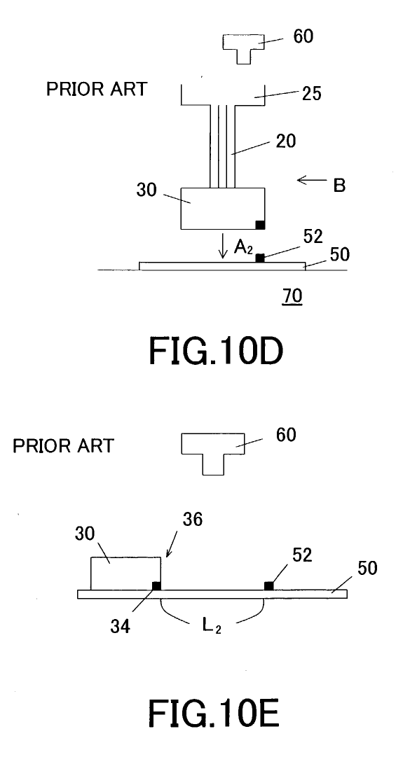

The pallet part 110 accommodates the LD 30 shown in FIG. 10, and sequentially supplies the LD 30 to the mount device 120. The pallet part 110 includes a pallet 111, an X-axis stage 116 and a Y-axis stage 118. The X-axis stage 116 and Y-axis stage 118 may be considered to be part of the mount device 120 and controlled by a control part 140, which will be described later.

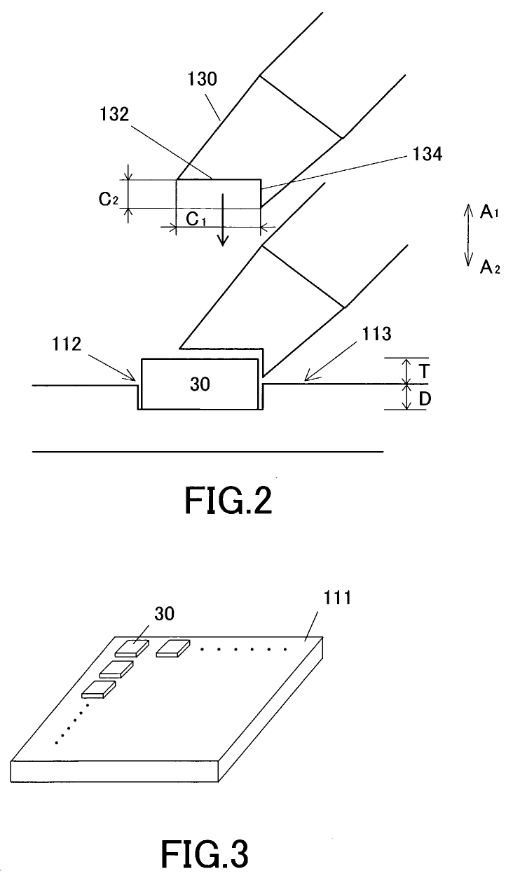

The pallet 111 includes multiple concave accommodation parts 112, which are arranged in a matrix array, and each accommodates, as shown in FIG. 3, the LD 30. Here, FIG. 3 is a schematic perspective view of the pallet 111 for accommodating LDs 30 like a matrix array. As shown in FIG. 2, the accommodation part 112 exposes part of the side surface of the LD 30 accommodated in it by a length T. The depth D of the accommodation part 112 is set so that a suction surface 134 of the collet 130, which will be described later, covers the exposed part of the side surface, or a length T is set longer than a length C₂ of the suction surface 134. As a result, the pallet 111 does not collide with the collet 130 due to the preset depth D of the accommodation part 112 when the collet 130 in the mount device 120 picks up the LD 30. Here, FIG. 2 is a schematic sectional view for explaining the depth D of the accommodation part 112 of the pallet 111. As shown in FIG. 10A, the conventional collet 20 extends from the bottom surface 24 as a suction surface vertically or in the direction A₁, and absorbs the top surface 32 of the LD 30 accommodated in the concave 12 after descending from the top to the bottom or in the direction A₂. Therefore, irrespective of the height or depth of the concave 12, the pallet 10 and collet 20 have never collide with each other. On the other hand, as the collet 130 of this embodiment forms obliquely extending suction parts 132 and 134, descends in the direction A₂, and absorbs the LD 30, the collet 130 may possibly collide with the surface 113 of the pallet 111 depending upon the depth D of the accommodation part 112. Therefore, the size of the pallet 111 of this embodiment is determined so as to prevent collisions with the collet 130.

Referring to FIG. 3, the rightwardly inclining collet 30 in this embodiment in FIG. 2 picks up the LD 30 from the right row to the left row. Therefore, the collet 130 never collides, when picking up one LD 30, with an adjacent LD 30. Of course alternatively, the LD 30 may be picked up from the left side row to the right side row in FIG. 3. In this case, the collet 130 may possibly collide, when picking up one LD 30, with an adjacent LD 30 depending upon the interval between adjacent accommodation parts 112. Therefore, in this case, the pallet 111 should arrange an interval between adjacent accommodation parts 112 so that the collet 130 does not collide with the LD 30.

The pallet 111 may be made of a gel pallet that mounts the LD 30 on an adhesion tape rather than arranging the LDs 30 in the concaves 112 shown in FIG. 2. The present invention does not limit the arrangement of the LDs 30 on the pallet 111 to the matrix array, or restrict the accommodated number of LDs 30 on the pallet 111.

The X-axis stage 116 and Y-axis stage 118 move the pallet 111 in the X-axis direction and Y-axis direction so as to change a position of the LD 30 that the collet 130 picks up. The X-axis stage 116 and Y-axis stage 118 may use any structure known in the art, such as a linear motor, and a detailed description thereof will be omitted.

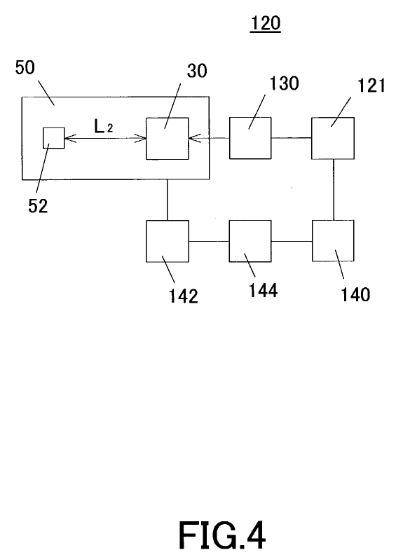

The mount device 120 serves to pick up the LD 30 from the pallet 111, carry it to the base 50, align it and mounts it onto the base 50. The mount device 120 has, as shown in FIG. 4, a drive part 121, a feed hand or suction collet 130, a control part 140, a camera 142, and an image processor 144. Here, FIG. 4 is a schematic block diagram of a control system in the mount device 120.

The drive part 121 serves to linearly move the collet 130 in and rotate it around three axes or X-axis, Y-axis, and Z-axis directions, and includes, as shown in FIG. 1, an X-axis stage 122, a Y-axis stage 123, a Z-axis stage 124, and a rotary stage 125. As a result, the deive part 121 enables the collet 130 to pick up the LD 30 from the pallet 111, carry the LD 30 from the pallet 111 to the base 50, aligns the LD 30 with the base 50 above the base 50, and mount the LD 30 onto the base 50. The X-axis stage 122 etc. may use any structure known in the art, such as a linear motor and encoder, and thus a detailed description thereof will be omitted.

The control part 140 covers one that controls each module in the mount device 120 irrespective of its name, such as a CPU and a MPU. For example, the control part 140 controls the pickup, feed, alignment and mount of the LD 30, but FIG. 3 shows a structure of the control part 140 for controlling the alignment by the drive part 121 based on data image-processed by the image processor 144. As mentioned above, the control part 140 in one embodiment controls the X-axis stage 116 and Y-axis stage 118.

The camera 142 has a similar structure to the camera 60 shown in FIGS. 10D and 10E, although not shown in FIG. 1, and located almost just above the base 50. It is preferable to provide the camera 142 almost just above the base 50. The camera 142 photographing from the upside provides better recognition accuracy than photographing obliquely.

The camera 142 has a field of 0.6 mm×0.5 mm and captures both of the LD 30 and the markings 50 formed on the base 50 before the LD 30 is mounted on the base 50. The image processor 144 is connected to the camera 142, processes images indicative of a position and orientation of the LD 30 relative to the markings 52 taken by the camera 142, and supplies the processed images to the control part 140. The camera 142 and image processor 144 may use any structure known in the art, and a detailed description thereof will be omitted.

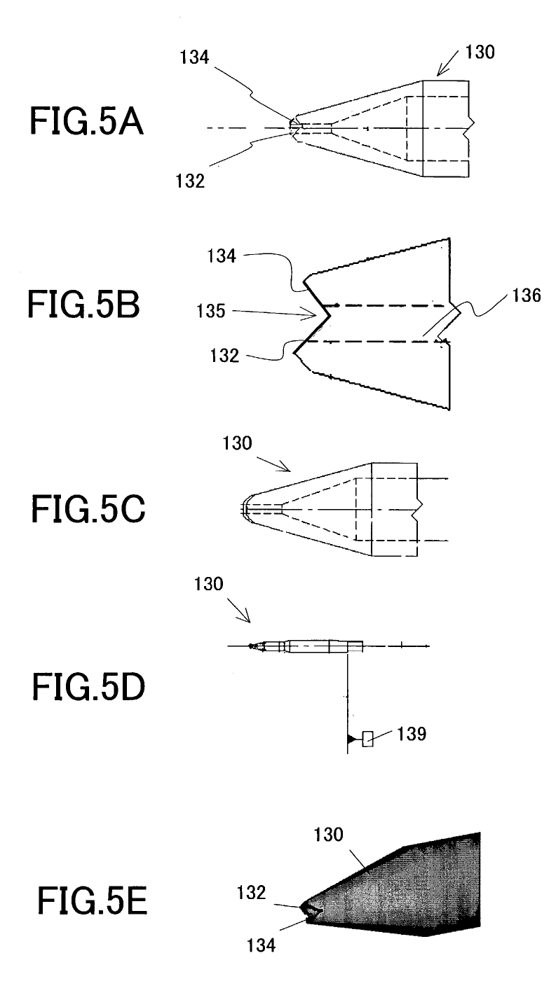

Referring now to FIG. 5, a description will be given of the collet 130. Here, FIG. 5A shows a partially transmitted sectional view of the collet 130. FIG. 5B is a partially enlarged view of its tip. FIG. 5C is a partially transmitted top view of the collet 130. FIG. 5D is a schematic sectional view of the collet 130. FIG. 5E is a schematic partial perspective view of the tip of the collet 130.

The collet 130 is made of conductive ultra steel having good workability. The collet 130 has suction surfaces 132 and 134, and forms a suction nozzle 136 at an interface between the suction surfaces 132 and 134 so that the nozzle 136 covers both of the suction surfaces 132 and 134.

The suction surface 132 absorbs the top surface 32 of the LD 30 shown in FIG. 10A, and the suction surface 134 absorbs the side surface 33 of the LD 30 shown in FIG. 10B. The collet 130 absorbs two surfaces of the upper surface 32 and side surface 33 of the LD 30 through the suction surfaces 132 and 134. Thus, the rough-search camera 40 shown in FIG. 10B and an image processor (not shown) connected to the camera 40 are not needed, and the mechanism becomes simple and inexpensive. The rough-search time is saved, lowering the necessary time to mount the LD 30 onto the base 50, and improving the yield.

Since it is sufficient that the collet 130 of this embodiment secures the object, the collet 130 may have a shape corresponding to the shape of the object and such a shape may have three or more surfaces and three-dimensional shape that cannot be strictly divided into two surfaces, such as curved and elliptical surfaces.

The suction nozzle 136 is connected to the suction surfaces 132 and 134, and serves to draw a vacuum. The suction nozzle 136 shifts towards the suction surface 132 to maintain a stable orientation of the LD 30 when absorbing it. Therefore, the absorptive power by the suction surface 132 is stronger than that by the suction surface 134. As a result of the eager study by the instant inventor, the stable absorption of the LD 30 is available when the suction surfaces 132 and 134 have different absorptive powers instead of having the same power, and the absorptive power to the top surface 32 of the LD 30 is set to be higher.

The LD has almost rectangular-parallelopiped shape and forms 90° between the top and side surfaces 32 and 34 of the LD 30. On the other hand, an angle between the suction surfaces 132 and 134 is set to be slightly larger, because the collet 130 may absorb the LD 30 even when a manufacture error makes the larger angle between the top and side surfaces 32 and 34. As a result, the suction surfaces 132 and 134 may absorb a manufacture error deviation between two surfaces on the LD 30. The angle between the suction surfaces 132 and 134 is set, for example, to be larger than the manufacture error of the LD 30. Since the excessively large angle would result in a loss of two-surface binding of the LD 30, the angle between the suction surfaces 132 and 134 is set to be within a range to maintain two-surface binding.

An interface 135 between the suction surfaces 132 and 134 is set apart from the attachment reference part 139 by a certain distance, as shown in FIG. 5D.

The collet 130 obliquely extends, as shown in FIG. 2, from the suction surfaces 132 and 134. The suction surfaces 132 and 134 expose part of the LD 30 after they absorb the LD 30. Therefore, a length C₁ of the suction surface 132 shown in FIG. 2 is smaller than a width of the top surface 32 of the LD 30. As discussed, the length C₂ of the suction surface 134 shown in FIG. 2 is set smaller than T of the LD 30. The partial exposure of the LD 30 by the collet 130 would facilitate the alignment between the LD 30 and markings 52 with a view from the upside.

The base part 180 includes the base 50 and bonding stage 70. The base part 180 may apply any structure known in the art, and a detailed description will be omitted.

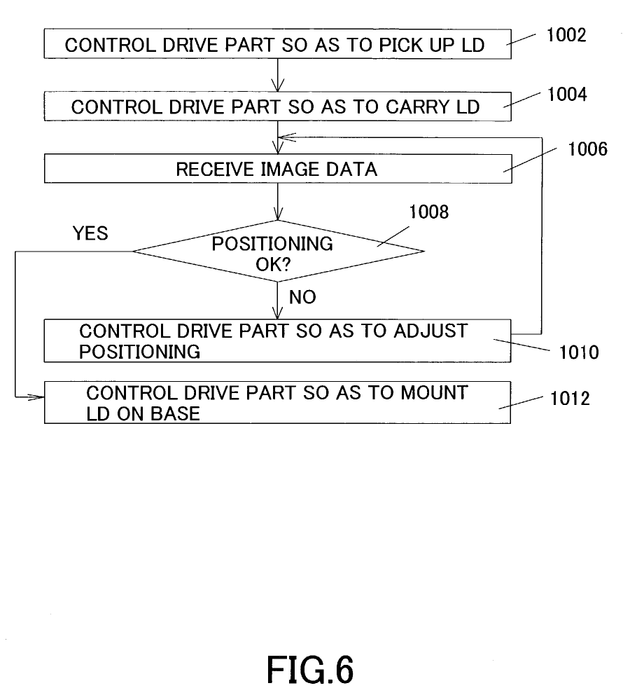

Referring now to FIG. 6, a description will be given of an operation of the control part 140. Here, FIG. 6 is a flowchart showing the operation of the control part 140. The flowchart shown in FIG. 6 may be implemented as a computer executable program.

First, the control part 140 controls the drive part 120 so as to pick up the LD 30 from the pallet 111 (step 1002). The control part 140 may also control the X-axis stage 116 and the Y-axis stage 118. The control part 140 further controls drawing a vacuum of the suction nozzle 136 in the collet 130, whereby the LD 30 may be picked up from the accommodation part 112 at a desired position in the pallet 111. As shown in FIG. 2, the drive part 121 descends in the direction A₂ after setting the suction surface 134 close to the side surface 33 on the LD 30.

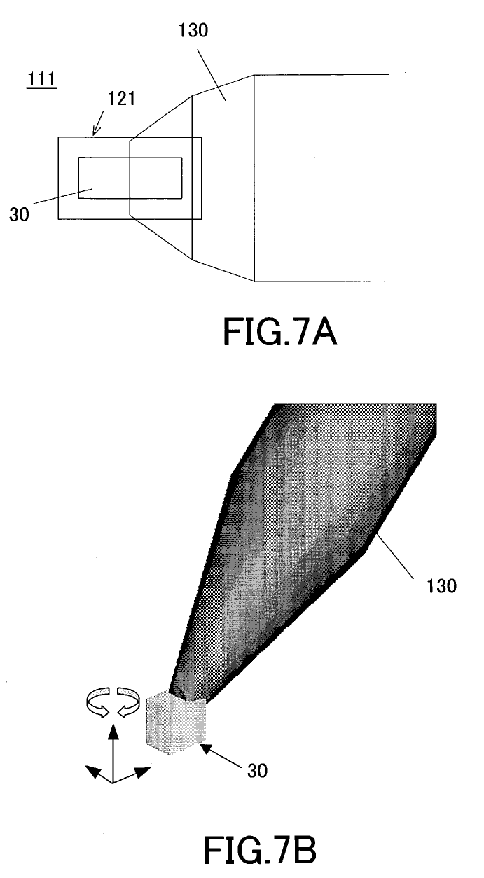

FIG. 7 shows this state. Here, FIG. 7A is a plane view of the collet 130 absorbing the LD 30. FIG. 7B is its perspective view. The LD 30 and the collet 130 have different sizes in both figures for constructional conveniences.

As shown in FIGS. 7A and 7B, the suction surface 132 exposes part of the LD 30 after it absorbs the LD 30. In picking up the LD 30, as discussed with reference to FIG. 2, the collet 130 does not collide with the top surface 113 of the pallet 111. In picking up the LD 30 from the pallet 111 using the collet 130, the LD 30 is absorbed with a clearance between the LD 30 and the collet 130. The LD 30 is absorbed by the suction surfaces 132 and 134 shown in FIG. 2, and a position and orientation of the LD 30 are fixed relative to the collet 130. In other words, the absorptive power of the collet 130 absorbs the LD 30 on the suction surfaces 132 and 134, and the orientation of the LD 30 becomes stable in the direction X and θ_{Z} by the absorptive power and binding surfaces of the collet 130. The impact applied to the LD 30 is affected by the own weight of the LD 30 and absorptive power, but it does not damage a fine part, such as an optical device, since the fine part has small weight and thus the impact is small.

Next, the control part 140 controls the drive part 121 so as to feed the LD 30 to the upside of the base 50 (step 1004). The control part 140 may controls so as to descend the LD 30 so that the LD 30 is set apart from the base 50 by a predetermined distance in the vertical direction. The alignment is provided at this point. In the alignment between both members are provided while a distance between the LD 30 and the base 50 is set about 1 μm in the vertical direction, the LD 30 may be mounted without affected by the accuracy of the drive part 121 that descends the collet 130 and LD 30. For example, suppose that the drive part 121 descends the collet 130 after the alignment with a large vertical distance between the LD 30 and the base 50. In this case, if the driving accuracy by the drive part 121 is not so high that an attempt to vertically descend the collet 130 results in the inclined descending of the collet 130, the LD 30 is mounted onto the base 50 at an offset position from a desired position. On the other hand, the instant embodiment aligns the LD 30 with the base 50 after arranging the LD 30 close to the base 50 so that mounting of the LD 30 is less affected by the driving accuracy by the drive part 121.

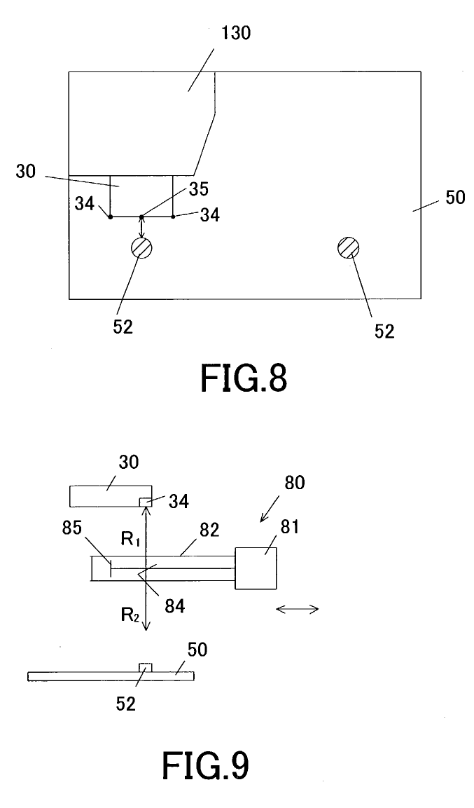

The driving part 141 then receives image data taken by the camera 142 from the image processor 144 (step 1006), and determines whether the alignment is proper or the length L₂ shown in FIG. 4 is the predetermined distance (step 1008). As discussed, the length L₂ is a distance between the marking 52 and the LD 30. The camera 142 has a field shown in FIG. 8. Here, FIG. 8 shows a plane view of the field of the camera 142.

When the alignment is insufficient, the control part 140 controls the drive part 121 so as to align the LD 30 and returns to the step 1006 (step 1010). The alignment sets to L₂ a distance between a center 35 between the markings 34 shown in FIG. 8 and the marking 52, and let a line that passes the center 35 and is perpendicular to a line connecting a pair of markings 34 pass the marking 52 or become parallel to a line that passes a center between the markings 52 and is perpendicular to a line connecting a pair of markings 52. Thereby, the LD 30 is aligned with the marking 52 with a desired distance and orientation or angle.

According to the mount device 120, the control part 140 thus aligns the LD 30 with the marking 52 before the LD 30 is mounted onto the base 50, and corrects the alignment through the drive part 121. Therefore, the mount device 120 does not require the rough-search camera 40 shown in FIG. 10B and the image processor (not shown). The instant embodiment uses the same image processing system and has higher alignment accuracy of the LD 30 with the marking 52 or mounting accuracy of the LD 30 than the conventional mounting method that uses different image processing systems. For example, the image processing by the camera 142 contains a recognition error as in the cameras 40 and 60, the recognition accuracy of the mount device 100 of this embodiment is twice as high as the conventional mount method shown in FIG. 10. Moreover, the alignment may be corrected before the LD 30 is mounted onto the base 50, the correction time becomes shorter than the conventional mount method that determines the necessity of the correction only after the LD 30 is mounted onto the base 50.

The camera 142 is located above both of the LD 30 and base 50, and provides better alignment accuracy than a camera located between the LD 30 and base 50. For example, as shown in FIG. 9, it is conceivable to use a camera 80, instead of the camera 142, which includes an imaging part 81 and an optical system 82. The optical system 82 includes mirror 84 and 85, and photographs the LD 30 and 50 simultaneously. However, this configuration is complex and expensive, and the insertion of the mirrors 84 and 85 causes an offset between optical axes of upper and lower rays R₁ and R₂, thereby lowering the recognition accuracy of the imaging part 81. In addition, when the imaging part 81 photographs the LD 30 and the base 50, the quantity of upper and lower light is not the same and thus the contrast is not the same, causing the recognition error in image-processing both data. Moreover, it is necessary to separate the LD 30 and the base 50 by a distance necessary for insertion of the camera 80. In this case, after the alignment using the camera 80, the camera 80 should be removed and the LD 30 should be mounted onto the base 50. However, if the driving accuracy of the drive part 121 is not so high that an attempt to vertically descend the LD 30 results in the inclined descending of the collet 130, the LD 30 is mounted onto the base 50 at an offset position from a desired position. Therefore, the camera 142 has higher recognition accuracy than the camera 80.

The control part 140 controls, when determining that the alignment is completed (step 1008), the drive part 121 so as to mount the LD 30 onto the base 50 (step 1012). Then, the LD 30 is solder-bonded with the base 50. Since L₂ is secured with predetermined accuracy, the bonding accuracy improves and provides an LD having good optical characteristics. Then, in mounting another LD 30 onto the same base 50 or mounting another LD 30 onto another base 50, the control part 140 repeats the procedure from the step 1002.

Further, the present invention is not limited to these preferred embodiments, and various modifications and variations may be made without departing from the spirit and scope of the present invention.

Thus, the inventive mount device and method do not require the rough-search camera 40 shown in FIG. 10B or the image processor (not shown) connected to the camera 40, simplifying its mechanism and reducing the cost. In addition, the inventive mount device and method do not require the time for the rough search, reducing the time necessary to mount the object onto the base, improving the yield. Moreover, the inventive mount device and method use the same image processing system, and thus provides higher alignment accuracy or mounting accuracy of the object to the marking.

What is claimed is:

1. A mount device for mounting an object onto a predetermined position on a base, said mount device comprising:
a support part including a first support surface for supporting one surface of the object, and a second support surface for supporting another surface of the object that neighbors the one surface of the object; and
a suction nozzle for absorbing the object through the first and/or second surfaces.

2. A mount device according to claim 1, wherein the support part exposes part of the object.

3. A mount device according to claim 1, wherein an angle formed between the first and second surfaces is larger than that formed between two surfaces on the object.

4. A mount device according to claim 1, wherein the suction nozzle covers an interface between the first and second support surfaces and has such a biased center that the first and second support surfaces absorb with difference absorbing powers.

5. A mount device according to claim 1, wherein the predetermined position is a predetermined position from a marking provided on the base, and
wherein the mount device further comprises:
an imaging part, provided at an upside of the base, which has a field to cover both of the object and marking before the object is mounted onto the base; and
a drive part for driving said support part so as to move the object toward the base, and correcting an alignment of the object with the marking when the object is not arranged in place relative to the marking.

6. A mount device according to claim 5, wherein said support part exposes part of the object viewed from said imaging part.

7. A mount device according to claim 5, wherein said imaging part is located approximately just above the base.

8. A mount device according to claim 5, wherein said drive part includes:
a XYZ stage for linearly moving said support part in three axial directions; and
a rotary stage for rotating said support part.

9. A mount device for mounting an object onto a predetermined position on a base, said mount device comprising a support part that includes a support surface corresponding to part of a three-dimensional shape of the object and supports the object through the support surface.

10. A mount device according to claim 1, wherein the object is a laser diode, and the base is provided on a bonding stage.

11. A method for mounting an object onto a base, said method comprising the steps of:
carrying the object to an upside of the base; and
capturing the object and a marking formed on the base simultaneously in the same field viewed from the upside of the base, and aligning the object with the marking using an imaging part located above the object and the base.

12. A method according to claim 11, wherein said aligning step is executed when the object is located within a predetermined distance from the base in a vertical direction.
